(19) United States
(12) Patent Application Publication
(10) Pub. No.: US 2015/0184411 A1
(43) Pub. Date: Jul. 2, 2015

(54) POOL LIFT

(71) Applicant: Peter A. Müller, Gattikon (CH)

(72) Inventor: Peter A. Müller, Gattikon (CH)

(21) Appl. No.: 14/390,300

(22) PCT Filed: Apr. 2, 2013
(86) PCT No.: PCT/CH2013/000056

§ 371 Date: Jan. 5, 2015

(30) Foreign Application Priority Data
Apr. 2, 2012 (CH) 465/12
Nov. 12, 2012 (CH) 2355/12

(51) Int. Cl. E04H 4/14; A61G 7/10

(52) U.S. Cl. CPC E04H 4/144; A61G 7/1005; A61G 7/1019; A61G 7/1044; A61G 7/1017

(57) ABSTRACT

The invention relates to a pool lift attached to the pool edge of a swimming pool and having a platform that is height-adjustable by means of a mechanical cylinder on a pivot lever and having rollers that engage the guide bar, secured against undesired lowering by means of gas springs or with closed buoyancy body and the platform may also accommodate underwater fitness equipment, countercurrent system, folding seat and has a training algorithm by means of a controller.

### TECHNICAL FIELD

The invention proceeds from a lift at a swimming pool in accordance with the preamble to the first claim, which lift is height adjustable and self-supporting and when needed a loading space in platform accommodates technical means.

### PRIOR ART

Submersible platforms are known for watercraft for hoisting devices, but also people, out of or lowering them into the water, as is described in patent US 2010/0089302 A1; also known are integrated treadmills, as described in patent US 2011/0294625A, US 2012/0010052 A1, and from the literature “Human thermoregulatory response during prolonged walking in water rate 25, 30 and 35°” in the European Journal of Applied Physiology and Occupational Physiology, Volume 78, Number 6, 473-478, and also from various other sports medicine devices for aqua sports or aqua fitness training.

### DESCRIPTION OF THE INVENTION

The invention proceeds from a swimming pool lift, having adjustable platform height, that is self-supporting, at least in the water area, and may be used for leisure activities, sports, rehabilitation, or people with limited mobility, such as seniors or mothers with small children, and where needed fitness or sports medicine equipment may be foldably mounted in the platform, according to the preamble of the first claim.

Given the requirement in public facilities to provide barrier-free access to the swimming pool, but also to make privately-owned swimming pools as versatile as possible, a pool lift is an efficient solution for transporting people into or out of the water and may also be used as a carrier for fitness and other equipment.

The inventive approach is to safely operate such a system, even when there is a power outage, and to use it as means for providing a water game or countercurrent system or fitness equipment, or to easily stow such heavy and cumbersome equipment.

In addition to the machine standards regarding safety clearances so that no limbs are trapped, the safety aspect therefore also includes covers for reliably preventing inter alia the gas spring from actuating. When the hydraulics fail, this ensures that the platform of the pool lift cannot drop downward, and when there is an electrical power outage, that the hydraulics may be unblocked by means of actuating a non-pressure switch and the platform moves safely upward to the edge of the swimming pool by means of the gas spring force. In addition, carrying structures in indoor swimming pools are subject to extremely rigorous safety requirements, which results in it being necessary to use stainless steel that is a higher quality than the standard stainless steel, and is thus more expensive. Therefore the platform is carried by floating bodies so that in the corrosive environment of a swimming pool, in which the air contains chlorine, when there is a rupture in material the platform is not able to fall downward, because it would then also float in the water of the swimming pool like a raft. For this reason a cost-effective stainless steel such as e.g. in accordance with DIN standard 1.4404 or 1.4462 may be used.

The other objective, to generate the greatest possible lift in the swimming pool, would mean that a large cylinder stroke would be necessary or a cable pulley having a corresponding roll-up mechanism and motor would have to assume the task. Therefore a pivot arm mechanism is ideal for reasons of cost. For this a parallelogram would be needed, but that might lead to pinching or shearing injuries and would therefore require coverings, in conformance with standards, that are complicated, also with respect to the platform of the pool lift.

To this end there is the solution of using a single pivot arm which is all that is necessary for adjusting the lift height, and the guide for the positionally-stable platform is attached to the guide bar with guide rollers. Thus a significantly smaller lift cylinder may be used, which saves space and money. The lift cylinder may be operated electrically or by means of a fluid, e.g. biopetroleum or clear water.

In addition, it is also possible to attach various sports equipment to the pool lift, whether a countercurrent system, treadmill, ergometer, pull-up bar, or the like, and for wellness a seating bench with air jets all the way to a waterfall and underwater lighting, for visual enjoyment.

Because of the secure platform, which is additionally secured by gas springs or the floating body, the system may be used as an active training means in that e.g. a button or even a microphone is attached to the pull-up bar and during the exercise may be actuated or voice-activated and thus the height of the pull-up bar may be changed and therefore the pull-up force may be varied for the athlete. Such a training regimen may also be automated by means of a controller.

In accordance with invention this is attained using the features of the first claim.

The core of the invention is to prevent a fall into the pool by means of a height-adjustable, self-supporting swimming pool lift by means of a gas spring or a floating body and to accomplish the height adjustment by means of a simple pivot arm and a guide on a guide bar and to install fitness equipment for underwater use directly in the pool lift and to offer a special training options by means of a switch, voice response, or controller.

Other advantageous embodiments of the invention result from the subordinate claims.

### BRIEF DESCRIPTION OF THE FIGURES

Exemplary embodiments of the invention are described in greater detail in the following using the drawings. Identical elements in the different figures are provided with the same reference number.

FIG. 1 is a schematic side view of a swimming pool lift at a swimming pool having a pivot lever that is attached to the bracket and that has a track guide on the platform and having two cylinders between bracket and pivot lever and the platform has rollers on the guide bar;

FIG. 2 is a schematic side view of a swimming pool lift at a swimming pool having a pivot lever that is attached to the bracket and that supports the platform and having a cylinder, as well as a set of floating bodies and the platform has rollers on a guide bar, as well as a trough with foldable equipment;

FIG. 3 is a schematic side view of a swimming pool lift at a swimming pool having a pivot lever that is attached to the bracket and that supports the platform and having a cylinder, as well as a set of floating bodies and the platform has rollers on a guide bar as well as a trough with a set of folding seats and having an illuminating waterfall;

FIG. 4 is a schematic side view of a swimming pool lift at a swimming pool having a pivot lever that is attached to the bracket and that supports the platform and having a cylinder, as well as a floating body with underwater lighting, a countercurrent system, a cable retention element, and pull-up bar, an electrical switch, an extension, and safety button, and a controller.

Only elements essential to immediately understanding the invention are depicted in the drawings.

### EMBODIMENTS OF THE INVENTION

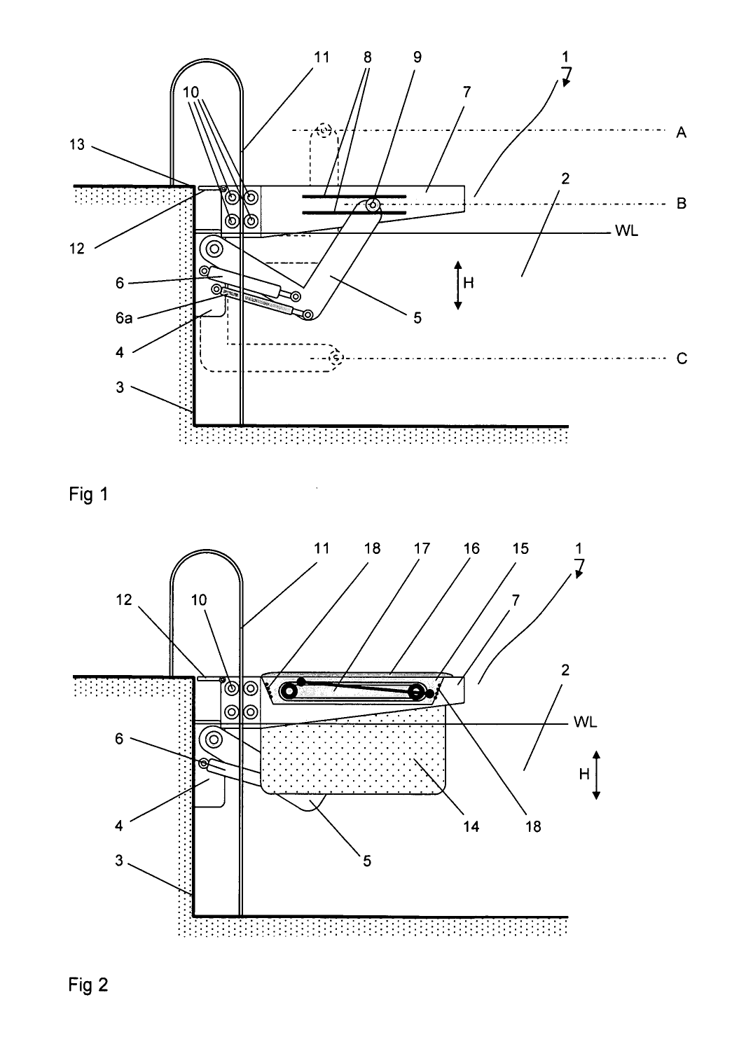

FIG. 1 is a schematic side view of a pool lift 1 that is at a swimming pool 3 filled with water 2 having a water line WL and that has a pivot lever 5 attached to the bracket 4 activates, by means of the mechanical cylinder 6 and the gas spring 6a, and a platform 7 that is supported horizontally by means of track guide 8 and wheel 9 and may be moved vertically by means of rollers 10 on a guide bar 11. A bar 12 connects the pool edge 13 to the platform 7.

In a pool lift 1 that must reliably prevent shearing and crushing points, a vertical lift is advantageous per se, wherein an cranked pivot lever 5 is exceptionally well suited for lifting and lowering the platform 7 and thus safety requirements may be satisfied in a cost-effective and uncomplicated manner. A mechanical cylinder 6 that is attached to the bracket 4 and that directly engages the pivot lever 5, the platform 7 raises and lowers across a high vertical distance, from the lift position A to C, simply, effectively, and with a small stroke on the mechanical cylinder 6. A wheel 9 is attached to the pivot lever 5 so that the pivot lever 5 can roll along beneath the platform 7 with little friction. A track guide 8 ensures that the pivot lever 5 remains in the track without having to operate a large complicated bearing guide on the bracket 4 and also so that when there are waves and therefore corresponding fluctuations in water pressure in the pool 3, the platform 7 is not able to raise up from the wheel 9 and come down hard again, but rather is held in the track guide 8 with little clearance.

The lift H and in particular the horizontal position of the platform 7 is ensured by means of the set of roller 10 that is attached to the platform 7 and that engage the guide bar 11, and thus lifting and lowering may be accomplished in a cost-effective manner by means only of a pivot lever 5 and a mechanical cylinder 6.

Hydraulic cylinders today have a high degree of sealing reliability and their holding capacity may be improved by means of load holding valves. Nevertheless, when it idles for a prolonged period, in many applications oil seeps through the seals, and for this reason load holding valves are not recommended for swimming pools. In addition, if the platform 7 has been lowered, if there is a power failure or a pump or hose defect it is not possible to move such a hydraulic system back up and this is a safety hazard. This problem is inventively solved by means of gas spring 6a that has a force that lifts the platform 7 and at least one person at least to the water line WL, but is technical configured such that it reaches the pool edge 13 or lift position B. The hydraulic system is therefore equipped with a manual non-pressure switch that neutralizes the entire hydraulics circuit so that the gas spring 6a moves the platform 7 upward. In addition, this relieves the chamber on the piston rod side when the pool lift 1 is not in use, thus ideally preventing oil from leaking.

With a specific geometry, the L-shaped, i.e. angulated, pivot lever 5 enables the best possible lift and makes it possible to construct the pool lift 1 to be extremely compact. The pool lift 1 may also be moved up above the pool edge 13 by means of the guide bars 11 to lift position A and in this way acts as a diving platform.

In addition, the guide bars 11 may be built into the swimming pool 3 vertically, or when necessary they may also be at an angle so that the pool lift 1 may be moved at an angle, e.g. from shallow water into deep water. Naturally the rollers 10 may be positioned relative to one another as appropriate for this.

If there is no overhang on the pool edge 13, a rotatably-borne bar 12 may be attached there to provide a link from the ground to the platform 7; it folds up when the platform is lowered in order to make room for the pivot lever 5.

The switch for lowering and raising the platform is not shown, nor are the hydraulic system and the required hoses.

The mechanical cylinder 6 may be operated electrically or by means of a fluid.

FIG. 2 is a schematic side view of a swimming pool lift 1 on a swimming pool 3 filled with water 2 with a water line WL and with a pivot lever 5 attached to the bracket 4, activated by means of the mechanical cylinder 6, and a platform 7 that may be moved vertically by means of rollers 10 on a guide bar 11. Disposed beneath the platform 7 is a buoyancy body 14 and in the platform 7 is a trough 15 with a movable cover 16, in which trough is disposed fitness equipment 17, for instance a foldable treadmill.

Instead of being embodied to use a gas spring 6a as in FIG. 1, one buoyancy body 14 is attached below the platform 7, or two are attached to the right and left of the pivot lever 5, which ensures that the task of reliably raising the platform is accomplished. The pivot lever has a closed cavity and is absolutely sealed or filled with foam and creates buoyancy that supports the platform 7 and one or two persons, as well as fitness equipment 17, and lifts the platform 7 to at least the water line WL. In this case the mechanical cylinder 6 must also press the platform 7 downward in order to have it move downward. When the platform is being raised, the mechanical cylinder 6 can simply let the fluid in the cylinder chamber flow back into the tank without activating the hydraulic pump because the buoyancy of the buoyancy body 14 provides the force for the lifting function.

Aqua-jogging on a treadmill and using an ergometer under water is a high-quality fitness training method. The equipment is heavy, however, since it is generally made of stainless steel and must be stably positioned under water. Likewise, after use the fitness equipment should be rinsed off with clean water because otherwise the high-quality steel will corrode due to the high concentrations of chlorine in the swimming pool 3. Although training with such underwater fitness equipment will make one extremely fit, repeatedly hauling the fitness equipment 17 around will injure one's back. For this reason the platform 7 has a trough 15 into which corresponding fitness equipment 17 may be placed in a space-saving manner and by means of the movable cover 16 the fitness equipment 17 may be completely covered with a suitable folding mechanism and thus is also not damaged. By means of such an installation it is possible to ensure that such fitness equipment 17 does not slip out of place under water and it may be simply moved below the water line WL and back above the water line, with no danger to the back or joints.

If for reasons of cost a high-quality steel material has not been chosen for a fitness equipment 17 on such a pool lift 1 with the trough 15 and cover 16 shown here, a plurality of spray nozzles 18 connected to a clean water hose may be built into the trough 15, and with the cover 16 closed the fitness equipment 17 may be rinsed clean by means of a water tap (not shown). Drain gutters and outlet then let the clean water flow into the swimming pool 3.

Such fitness equipment 17 may be a treadmill, ergometer, rowing machine, or the like, and may also be actuated by motor by means of a watertight motor.

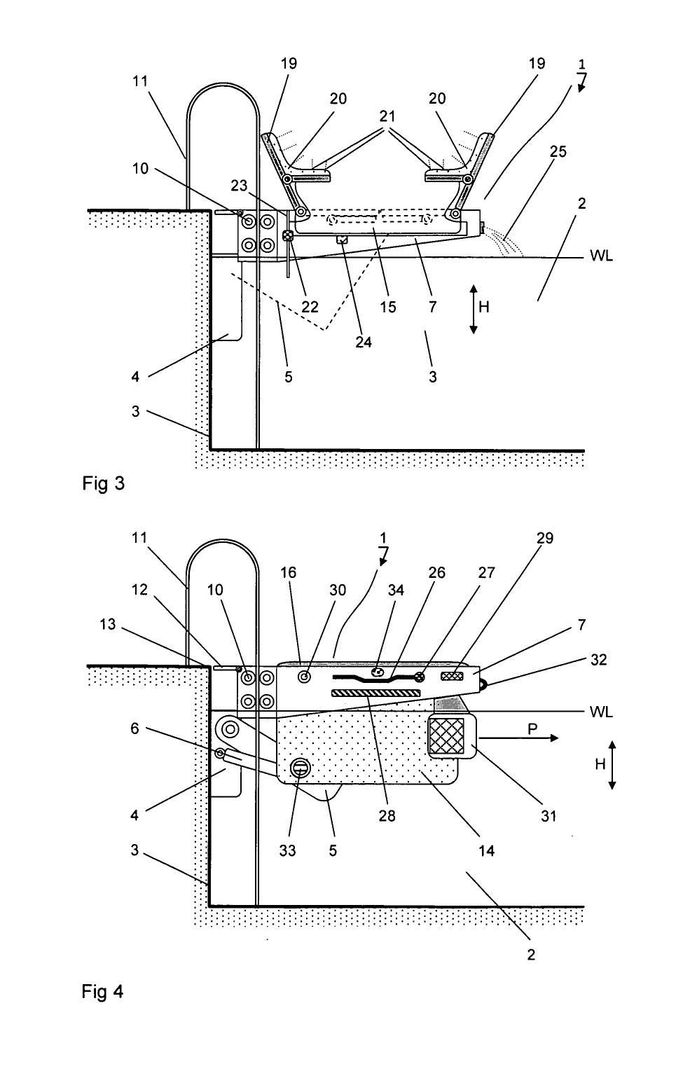

FIG. 3 is a schematic side view of a pool lift 1 at a swimming pool 3 having a pivot lever 5 that is attached to the bracket and that supports the platform 7 and the platform has rollers 10 on a guide bar 11 as well as a trough 15 with a set of folding seats 19 that, when closed, form one plane of the platform 7 and when open also have a spray function when needed. The spray function has seat mats 20 that have multiple openings 21 through which flows water or air or both together and the water is drawn from the swimming pool 3 by the pump 22 and flows through the openings 21 under pressure. Air may be drawn in by means of the suction line 23 and, by means of a switch (not shown), it is thus possible to conduct only air or only water or water and air into the seat mats 20. A pulsation module 24 provides an intense massage function. The water and/or the air may also be heated in the seat mats in order to provide an optimum spray function. In addition, disposed on the front side of the platform 7 is an opening for a waterfall 25 which is also beautifully lit from inside, providing the pool lift 1 another function at night.

FIG. 4 is a schematic side view of a pool lift 1 at a swimming pool 3 having a pivot lever 5 that is attached to the bracket and that supports the platform 7 and the platform has rollers 10 on a guide bar 11 and has a buoyancy body 14 with underwater lighting, a countercurrent system, a cable retention element, a pull-up bar, an electrical switch, an extension, a safety button, and a controller.

Another advantage of the height-adjustable platform 7 is the use of the height-regulation for the pull-up bars 26 during aquasports training in that the athlete does pull-ups in the water and this exercise may be designed to be more or less difficult due to the body's buoyancy. If the pull-up bar 26 is attached just a little higher than the water line WL, the athlete may have less distance to pull up and the body automatically creates so much buoyancy that the exercise is easy to perform. The higher the pull-up bar 26 is brought above the water line WL, the greater the pull-up distance, the more the body comes out of the water 2, the more difficult the exercise. By means of the electric switch 27 on the pull-up bar 26, the athlete may first set the highest degree of difficulty for the exercises, that is, may move the pull-up bar 26 so high above the water line WL that the body comes far out of the water 2 and thus creates little buoyancy and therefore the amount of exertion is correspondingly at its greatest. After the first set of exercises, the athlete may enter a command on the switch 27 to move the pull-up bar 26 down by a certain amount so that the exercise becomes easier because more of the body is submerged and therefore the body creates more buoyancy. But since the athlete's muscles are already tired, this exercise is still difficult and thus by means of actuating the switch 27, the pull-up bar 26 may be lowered gradually or in steps as appropriate until the athlete's muscles can no longer continue. According to this method, it is also possible to perform appropriate exercises on the extension 28, such as e.g. sit-ups, to strengthen the abdominal and back muscles: after a number of movements completely out of the water 2 the muscles are no longer able to perform the exercise cleanly, and so the extension 28 is lowered by a unit of distance so that the body is partly supported by means of its own buoyancy in the water 2 and the exercise can be continued until finally even at the lowest level the athlete's muscles are exhausted. The extension 28 is a board that may be extended or suspended from the platform 7 and that has a mass such that a person may sit or lie comfortably on it.

Instead of switch 27, it is also possible for a microphone 34 to be built in on the platform 7 and for the height of the platform 7 to be controlled by means of speech recognition.

A novel training method may also be introduced by means of the pull-up bar 26 attached to the height-adjustable platform 7 by means of the controller 29 provided with a fixed or self-selected program: The athlete assumes a certain pull-up position, e.g. holding his body with his torso down to his navel above the water line WL. Now the pull-up bar 26 moves upward and downward automatically by a certain amount and during this movement the athlete attempts to keep his body position at a constant height relative to the water line WL. If the exercise cannot be maintained any longer after e.g. 10 pull-ups, the athlete may permit his torso to move downward somewhat and then attempt to accomplish 10 more pull-ups holding his body at a constant height at the new level with that much more body buoyancy, etc. This training method is suitable both for performance athletes and for therapeutic applications. If the athlete is completely exhausted after the training or if he does not feel well or has become dizzy from hyperventilation, it may be that he no longer has the strength to climb the ladder attached to the pool edge 13. In this case the athlete may press the safety button 30, a type of emergency switch shaped like a red mushroom as in industry that is attached to the platform 7. This stops the sports program immediately, e.g. even the swimming program on the countercurrent system 31. The platform 7 lowers below the water line WL by a certain amount so that the athlete can swim over or pull himself to the platform 7 and a few seconds later the platform 7 automatically moves up above the water line WL to the position of the swimming pool edge 3a.

The height-adjustable platform 7 also permits the height of the countercurrent system 31 to be adjusted such that it is slightly above the water line WL and its height is limited by means of the controller 29, wherein the propeller current P is output as an intense jet stream just below the surface of the water WL, which permits surfing by means of a surfboard and a cable that is attached to the fastening hook 32 on the platform 7. In particular children rapidly learn to maintain their balance and to steer the surfboard laterally by shifting their weight and to slalom in the swimming pool 3 despite being in a fixed location.

In addition there is an underwater illumination unit 33 disposed on the buoyancy body 14.

The use of a lifting means in the form of a pool lift 1 with the fitness equipment 17 and the practical use of a switch 27 or a microphone 34 with speech recognition for controlling a lift position A-B-C may also be applied logically with other lift designs.

Naturally the invention is not limited to the illustrated and described exemplary embodiments.

### REFERENCE LIST

1 Pool lift
2 Water
3 Swimming pool
4 Bracket
5 Pivot lever
6 Mechanical cylinder
6a Gas spring
7 Platform
8 Track guide
9 Wheel
10 Roller
11 Guide bar
12 Bar
13 Pool edge
14 Buoyancy body
15 Trough
16 Cover
17 Fitness equipment
18 Spray nozzle
19 Folding seat
20 Seat mats
21 Openings
22 Pump
23 Suction line
24 Pulsation module
25 Water fall
26 Pull-up bar
27 Switch
28 Extension
29 Controller
30 Safety button
31 Countercurrent system
32 Fastening hook
33 Underwater illumination unit
34 Microphone
WL Water line
P Propeller current
A B C Lift position

1. Pool lift
wherein
the bracket is attached to the pool edge of the swimming pool and a pivot lever and a mechanical cylinder are attached to the bracket and the mechanical cylinder engages the pivot lever and the latter moves the platform vertically through the lift positions A-B-C and holds it in each desired position and rollers are attached to the platform that engage the vertical or cranked guide bar and attached beneath the platform is a track guide in which a wheel may be moved horizontally and the latter is connected rotationally borne to the pivot lever, and at least one of the additional elements is attached, which is a safety lifting means having hydraulics with a non-pressure switch, a movable cover underwater fitness equipment, a folding seat, a spray nozzle, a seat mat, a waterfall a countercurrent system, a pull-up bar, an extension, a switch, a safety button, a controller.

2. Pool lift in accordance with claim 1,
wherein
the buoyancy body is sealed, hollow, or filled with foam.

3. Pool lift in accordance with claim 1,
wherein
embedded in the platform is a trough that accommodates foldable fitness equipment and is secure by means of the cover and is supplied in a manner that is not visible or acts as a loading space.

4. Pool lift in accordance with claim 1,
wherein
embedded in the platform is a trough that accommodates a folding seat and the cover may be part of the folding seat and the folding seat has a seat mat with openings through which flows water, air, or both by means of conveyance by the pump, and a pulsation module may be attached to the feed line.

5. Pool lift in accordance with claim 1,
wherein
spray nozzles are embedded in the trough and are connected to clean water or a cleanser that cleans the fitness equipment or the folding seat.

6. Pool lift in accordance with claim 1,
wherein
attached to the height-adjustable platform are a pull-up bar, extension, switch, microphone, fastening hook, safety button, controller.

7. Pool lift in accordance with claim 6,
wherein
instead of actuating the switch, the microphone controls the lift of the platform and is connected to a speech recognition unit.

8. Pool lift in accordance with claim 1,
wherein
the controller includes a program that automatically moves the height-adjustable platform with the pull-up bar up and down and when the safety button is actuated all of the athletic programs are stopped and at the same time the height adjustable platform moves below the water line and after a pause automatically moves up to the position of the swimming pool edge.

9. Pool lift in accordance with claim 1,
wherein
the mechanical cylinder works by means of a fluid or by means of an electrical drive.

10. Pool lift in accordance with claim 1,
wherein
the function of the mechanical cylinder is to act against the buoyancy of the buoyancy body or against the gas volume in the gas spring and thus to lower the platform.
